(19) United States
(12) Patent Application Publication
(10) Pub. No.: US 2003/0005172 A1
(43) Pub. Date: Jan. 2, 2003

(54) APPARATUS, METHOD AND COMPUTER PROGRAM PRODUCT FOR CLIENT/SERVER COMPUTING WITH IMPROVED CORRESPONDENCE BETWEEN TRANSACTION IDENTIFIERS WHEN SUPPORTING SUBORDINATE RESOURCE MANAGER(S)

(76) Inventor: AMANDA ELIZABETH CHESSELL, ALTON (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 09/247,464

(22) Filed: Feb. 9, 1999

(30) Foreign Application Priority Data
Jul. 22, 1998 (GB) 9815825.6

(51) Int. Cl. G06F 9/00; G06F 9/54; G06F 15/163; G06F 9/46

(52) U.S. Cl. 709/316; 709/101

(57) ABSTRACT

A server for use in a client/server computing system which coordinates the processing of distributed transactions in the client/server computing system, has: (a) a basic transaction service having a table which associates a server thread with transactional information identifying a transaction currently assigned to the server thread, the transactional information being in a format of the basic transaction service, and the information including a first transactional identifier; and (b) means for maintaining synchronism between the transactional information in the format of the basic transaction service and transactional information in a format of a subordinate resource manager when a server thread switches from one transaction to another transaction, including a mapping means for mapping between the first transactional identifier and a second transactional identifier, wherein the second transactional identifier is associated with a class defining at least one abstract method, the class having a subclass which provides transactional information in the format of the subordinate resource manager.

### FIELD OF THE INVENTION

The invention relates to the field of client/server (also known as “distributed”) computing, where one computing device (“the client”) requests another computing device (“the server”) to perform part of the client's work. The client and server can also be both located on the same physical computing device.

### BACKGROUND OF THE INVENTION

Client/server computing has become more and more important over the past few years in the information technology world. This type of distributed computing allows one machine to delegate some of its work to another machine that might be, for example, better suited to perform that work. For example, the server could be a high-powered computer running a database program managing the storage of a vast amount of data, while the client is simply a desktop personal computer (PC) which requests information from the database to use in one of its local programs.

The benefits of client/server computing have been even further enhanced by the use of a well-known computer programming technology called object-oriented programming (OOP), which allows the client and server to be located on different (heterogeneous) “platforms”. A platform is a combination of the specific hardware/software/operating system/communication protocol which a machine uses to do its work. OOP allows the client application program and server application program to operate on their own platforms without worrying how the client application's work requests will be communicated and accepted by the server application. Likewise, the server application does not have to worry about how the OOP system will receive, translate and send the server application's processing results back to the requesting client application.

Details of how OOP techniques have been integrated with heterogeneous client/server systems are explained in U.S. Pat. No. 5,440,744 and European Patent Published Application No. EP 0 677,943 A2. These latter two publications are hereby incorporated by reference. However, an example of the basic architecture will be given below for contextual understanding of the invention's environment.

As shown in FIG. 1, the client computer 10 (which could, for example, be a personal computer having the IBM OS/2 operating system installed thereon) has an application program 40 running on its operating system (“IBM” and “OS/2” are trademarks of the International Business Machines corporation). The application program 40 will periodically require work to be performed on the server computer 20 and/or data to be returned from the server 20 for subsequent use by the application program 40. The server computer 20 can be, for example, a high-powered mainframe computer running on IBM's MVS operating system (“MVS” is also a trademark of the IBM corp.). For the purposes of the present invention it is irrelevant whether the requests for communications services to be carried out by the server are instigated by user interaction with the first application program 40, or whether the application program 40 operates independently of user interaction and makes the requests automatically during the running of the program.

When the client computer 10 wishes to make a request for the server computer 20's services, the first application program 40 informs the first logic means 50 of the service required. It may for example do this by sending the first logic means the name of a remote procedure along with a list of input and output parameters. The first logic means 50 then handles the task of establishing the necessary communications with the second computer 20 with reference to definitions of the available communications services stored in the storage device 60. All the possible services are defined as a cohesive framework of object classes 70, these classes being derived from a single object class. Defining the services in this way gives rise to a great number of advantages in terms of performance and reusability.

To establish the necessary communication with the server 20, the first logic means 50 determines which object class in the framework needs to be used, and then creates an instance of that object at the server, a message being sent to that object so as to cause that object to invoke one of its methods. This gives rise to the establishment of the connection with the server computer 20 via the connection means 80, and the subsequent sending of a request to the second logic means 90.

The second logic means 90 then passes the request on to the second application program 100 (hereafter called the service application) running on the server computer 20 so that the service application 100 can perform the specific task required by that request, such as running a data retrieval procedure. Once this task has been completed the service application may need to send results back to the first computer 10. The server application 100 interacts with the second logic means 90 during the performance of the requested tasks and when results are to be sent back to the first computer 10. The second logic means 90 establishes instances of objects, and invokes appropriate methods of those objects, as and when required by the server application 100, the object instances being created from the cohesive framework of object classes stored in the storage device 110.

Using the above technique, the client application program 40 is not exposed to the communications architecture. Further the service application 100 is invoked through the standard mechanism for its environment; it does not know that it is being invoked remotely.

The Object Management Group (OMG) is an international consortium of organizations involved in various aspects of client/server computing on heterogeneous platforms with distributed objects as is shown in FIG. 1. The OMG has set forth published standards by which client computers (e.g. 10) communicate (in OOP form) with server machines (e.g. 20). As part of these standards, an Object Request Broker (called CORBA- the Common Object Request Broker Architecture) has been defined, which provides the object-oriented bridge between the client and the server machines. The ORB decouples the client and server applications from the object oriented implementation details, performing at least part of the work of the first and second logic means 50 and 90 as well as the connection means 80.

As part of the CORBA software structure, the OMG has set forth standards related to “transactions” and these standards are known as the OTS or Object Transaction Service. See, e.g., CORBA Object Transaction Service Specification 1.0, OMG Document 94.8.4. Computer implemented transaction processing systems are used for critical business tasks in a number of industries. A transaction defines a single unit of work that must either be fully completed or fully purged without action. For example, in the case of a bank automated teller machine from which a customer seeks to withdraw money, the actions of issuing the money, reducing the balance of money on hand in the machine and reducing the customer's bank balance must all occur or none of them must occur. Failure of one of the subordinate actions would lead to inconsistency between the records and the actual occurrences.

Distributed transaction processing involves a transaction that affects resources at more than one physical or logical location. In the above example, a transaction affects resources managed at the local automated teller device as well as bank balances managed by a bank's main computer. Such transactions involve one particular client computer (e.g., 10) communicating with one particular server computer (e.g., 20) over a series of client requests which are processed by the server. The OMG's OTS is responsible for co-ordinating these distributed transactions.

Usually, an application running on a client process begins a transaction which may involve calling a plurality of different servers, each of which will initiate a server process to make changes to its local database according to the instructions contained in the transaction. The transaction finishes by either committing the transaction (and thus all servers finalize the changes to their local databases) or aborting the transaction (and thus all servers “rollback” or ignore the changes to their local databases). To communicate with the servers during the transaction (e.g., instructing them to either commit or abort their part in the transaction) one of the processes involved must maintain state data for the transaction. This usually involves the process to set up a series of transaction state objects, one of which is a Coordinator object which coordinates the transaction with respect to the various server processes.

The basic software architecture involved in providing an implementation of the OTS is shown in FIG. 2. A client process 21 which wants to begin a transaction (e.g., to withdraw money from a bank account) locates a process which is capable of creating and holding the transaction objects that will maintain the state of the transaction. As the modern tendency is to create clients that are “thin” (and thus have only the minimum functionality), the client process 21 will usually not be able to maintain the transaction objects locally and must look for a server process for this purpose.

The OTS (or another service, such as the CORBA Lifecycle service) selects server A process 22 on which to create the transaction state objects 221 (which include the Coordinator object, Control object and Terminator object). Upon locating the server A process 22, client process 21 sends (arrow with encircled number 1) a message to server A process 22 to instruct server A process 22 to create the transaction state objects 221. The Control object (known in the OTS as CosTransactions::Control) provides access to the other two transaction state objects. The Terminator object (known in the OTS as CosTransactions::Terminator) is used to end the transaction. The Coordinator object (known in the OTS as CosTransactions::Coordinator) maintains a list, in local storage 222, of resource objects (known in the OTS as CosTransactions::Resource) that have made updates to their respective data during the transaction. This list is required so that the Coordinator object can consistently call the resource objects at the end of the transaction to command them to commit their transactional changes (make their local data changes final) or to rollback such changes (bring the local data back to the state it was in before the transaction started). A rollback would be necessary, for example, where the transaction could not finish because one of the resources was not working properly.

Server A process 22 then creates the transaction state objects 221 and sends a reply (arrow with encircled number 2) containing the transaction context to client 21. Client 21 then sends, for example, a debit bank account command (arrow with encircled number 3) to server B process 23 (the process containing the resource, for example, bank account, object 231 which the client process 21 wishes to withdraw money from). This latter command carries with it the transaction context supplied to the client 21 by the server A process 22. In this way, the resource object 231 in process 23 can register itself (arrow with encircled number 4) with the transaction objects 221 in process 22 so that the resource object 231 can be commanded (arrow with encircled number 5) to commit or rollback by the transaction state objects 221 at the end of the transaction.

In the above operation, when the transaction state objects 221 are created, they must log information about themselves and the transaction they represent in local storage 222, so that the transaction will be recoverable in case of a server failure which temporarily prevents the server A process 22 from continuing with the transaction.

As part of the transaction, the client process 21 then makes similar calls to server C process 24 (to access the resource object 241) and server D process 24 (to access the resource object 251). Server B process 23, in carrying out its part of the transaction, may need to call another server process, such as server E process 26, to access the resource objects 261, 262 and 263 located in process 26.

Since the number of server processes and resources involved in FIG. 2 is becoming large, the need for careful synchronization of all of the database changes involved becomes readily apparent. The usual way to go about achieving this synchronization is to carry out a two-phase commit process when the client 21 issues a command to end the transaction. The transaction objects 221 first command (phase 1) each of their directly registered resources (231, 241 and 251 in the FIG. 2 example) to prepare to commit their database changes. Phase 1 is also known as the prepare stage of a transaction, as the resources are being prepared for the finalization of their data changes, which will take place in phase 2. Each of these resources then responds to the transaction objects 221 to indicate that it has prepared to commit its changes, and the resources will not allow any more changes to be made to the databases. This response is, in effect, a vote, signifying that this particular resource is voting that the transaction should be committed. After issuing their votes, the resources are then said to be sitting “in doubt” (also known as in a “prepared” state) waiting for the transaction objects 221 to give a synchronized final command (phase 2) to commit all database changes made during the transaction. This latter final command is only given if all resources have voted that the transaction should be committed.

Server B process 23, which has called another server process 26, would carry out its own two-phase commit protocol with respect to the resource objects 261, 262, and 263, as part of its participation in the main two-phase commit protocol discussed above. That is, server B process 23 would send a prepare command to its directly registered resources 261, 262 and 263, and receive a vote from each of them, before server B process 23 sends a consolidated reply to server A process 22.

Rather than voting that a transaction be committed, a resource can also vote that a transaction should be rolled back. A rollback vote would be issued by a resource if that resource had a problem while making its data changes during the transaction (e.g., some type of write error had occurred while a resource was making a local data change). The receipt of a rollback vote from at least one resource will cause the transaction objects 221 to rollback the entire transaction. This is in keeping with the fact that a transaction is an all or nothing prospect: either all resource changes in a transaction are committed or none are.

Oftentimes, it is useful for a server running an implementation of the CORBA OTS to access resources being managed by a resource manager which uses a transaction service different from the CORBA transaction service. Each such transaction service is unique in that it has its own way of recovering from system crashes, its own way of identifying a transaction and for basically allowing servers to communicate with each other during the running of a transaction. IBM's Component Broker Connector product (“component Broker Connector” is a trademark of IBM Corp.), which was first announced in May of 1997, exploits the idea that transactions on external (also known as subordinate) resource managers such as XA enabled databases (which are described in Distributed Transactions Processing: The XA+ Specification Version 2, ISBN 1-85912-046-6, Document Number: S423, published in the United Kingdom by the Open Group, June 1994) can be controlled by a CORBA OTS implementation through the use of specialist implementations of the CosTransactions::Resource interface which are local to (i.e., in the same server process as) and registered with the CosTransactions::Coordinator object for the appropriate local transaction.

In a server running a transaction service (e.g., a Component Broker server running an implementation of the CORBA OTS), there is a design assumption that the work being done by a thread in the server is automatically assumed to be part of the transaction that has been associated with the thread. This transaction is called the current transaction and one of the responsibilities of the CORBA OTS is to return information about the current transaction when requested. The CORBA OTS, therefore, maintains a mapping between the threads in the server and the transactions associated with them. For example, the CORBA OTS keeps the following map:

TABLE 1

| thread identifier | transaction information |
|---|---|
| x | transaction name (a character string) |
| | costransactions: :otid_t |
| | local id (an integer) |

Thus, for each thread identifier (e.g., thread x), a group of transaction information for the current transaction running on the corresponding thread is stored in the mapping table. This group of transaction information includes a transaction name (which is represented by a character string), the costransactions::otid_t identifier (used by the CORBA OTS to identify a transaction) and a local id (an integer used for quick reference to a transaction). The CORBA OTS implementation can then be asked to provide the transaction information of the current transaction running on a thread. It is very common for a thread to frequently switch between transactions, and when a thread switches to a new transaction, the above mapping table must be updated with the new transaction information to reflect the fact that the thread now has a different transaction as its current transaction.

The software code that interfaces between the CORBA OTS and the SRM products also needs to maintain a mapping between the thread identifier and the current transaction. However, the information that each SRM needs about the transaction relates to that SRM's version of the transaction identification data and not the CORBA OTS's version of such data. As stated above, each transaction service has its own format for identifying a transaction. The CORBA OTS uses the CosTransactions::otid_t format, the XA specification, used primarily by databases, uses the XID format and IBM's SNA sync point (sync-level 2) services architecture uses the LUWId format.

As there are many different types of transaction services available, it is highly conceivable that it will be necessary to provide support for the CORBA OTS to call a plurality of different subordinate resource managers potentially in the same transaction, each SRM having its own transaction service associated therewith. For example, it might also be useful to provide support for SNA sync-level 2 enabled resource managers (also known as APPC) as well as an XA-based SRM. Co-pending IBM patent application docket number UK9-98-056, filed as UK patent application no. GB 9815207.7 on Jul. 15, 1998, places a mapping layer between the CORBA OTS and the various SRMs so that the SRMs can easily be added to the overall server architecture without requiring modification to the basic OTS transaction service. However, since each SRM has its own format for identifying a transaction, separate mapping lists of thread identifier versus transaction information would have to be maintained for each supported SRM. Whenever a transaction is moved from one thread to another in the server by the OTS, each such mapping list needs to be updated in addition to the updating of the OTS's own mapping table (i.e., Table 1). This creates a large administrative burden in trying to keeping all of such lists in synchronization with each other, and in synchronization with the OTS's main list (e.g., Table 1). Also, the plurality of lists itself adds much complexity to the overall software architecture of a transaction server apparatus, thus making such apparatus more expensive to design and maintain.

There is a great need in this art for a transaction server which is more efficiently implemented so that it can better support subordinate resource manager(s) to take part in a transaction.

### SUMMARY OF THE INVENTION

According to a first aspect, the present invention provides a server for use in a client/server computing system which coordinates the processing of distributed transactions in the client/server computing system, the server has:

(a) a basic transaction service having a table which associates a server thread with transactional information identifying a transaction currently assigned to the server thread, the transactional information being in a format of the basic transaction service, and the information including a first transactional identifier; and

(b) means for maintaining synchronism between the transactional information in the format of the basic transaction service and transactional information in a format of a subordinate resource manager when a server thread switches from one transaction to another transaction, including a mapping means for mapping between the first transactional identifier and a second transactional identifier, wherein the second transactional identifier is associated with a class defining at least one abstract method, the class having a subclass which provides transactional information in the format of the subordinate resource manager.

According to a second aspect, the invention provides a method of operating a server for use in a client/server computing system which coordinates the processing of distributed transactions in the client/server computing system, the method comprising steps of: receiving a request for transactional information of a current transaction in a format of a subordinate resource manager;looking up a first transactional identifier in a table which associates a server thread with transactional information identifying a transaction currently assigned to the server thread, the transactional information being in a format of the basic transaction service, and the information including the first transactional identifier; using the first transactional identifier to look up a second transactional identifier in a table for mapping between the first transactional identifier and a second transactional identifier, wherein the second transactional identifier is associated with a class defining at least one abstract method, the class having a subclass which provides transactional information in the format of the subordinate resource manager; obtaining the transactional information of the current transaction in the format of the subordinate resource manager from an implementation of the subclass; and returning the transactional information of the current transaction in the format of a subordinate resource manager as requested.

According to a third aspect, the invention provides a computer program product stored on a computer readable storage medium for, when run on a computer, carrying out the functionality of the second aspect.

Thus, with the present invention, whenever the basic transaction service (e.g., the OTS) changes the thread/transaction association, only the basic transaction service mapping list (i.e., Table 1) need be updated, and there is no need to make corresponding changes in similar mapping lists for each supported SRM. There is a single implementation of the code that manages the mapping between an SRM's transaction information format and the OTS's transaction information format. This saves development time and greatly simplifies the process of maintaining the server apparatus.

### BRIEF DESCRIPTION OF THE DRAWINGS

The invention will be better understood by the below description of preferred embodiments thereof to be read while referring to the following figures.

FIG. 1 is a block diagram of a well-known heterogeneous client/server architecture using object technology, in the context of which preferred embodiments of the present invention can be applied;

FIG. 2 is a block diagram showing an implementation of an object-based transaction server which serves as background to the present invention;

FIG. 3 is a block diagram showing a transaction server implementation according to a preferred embodiment of the present invention; and

FIG. 4 is a class diagram showing the class relationship between some of the classes according to a preferred embodiment of the present invention.

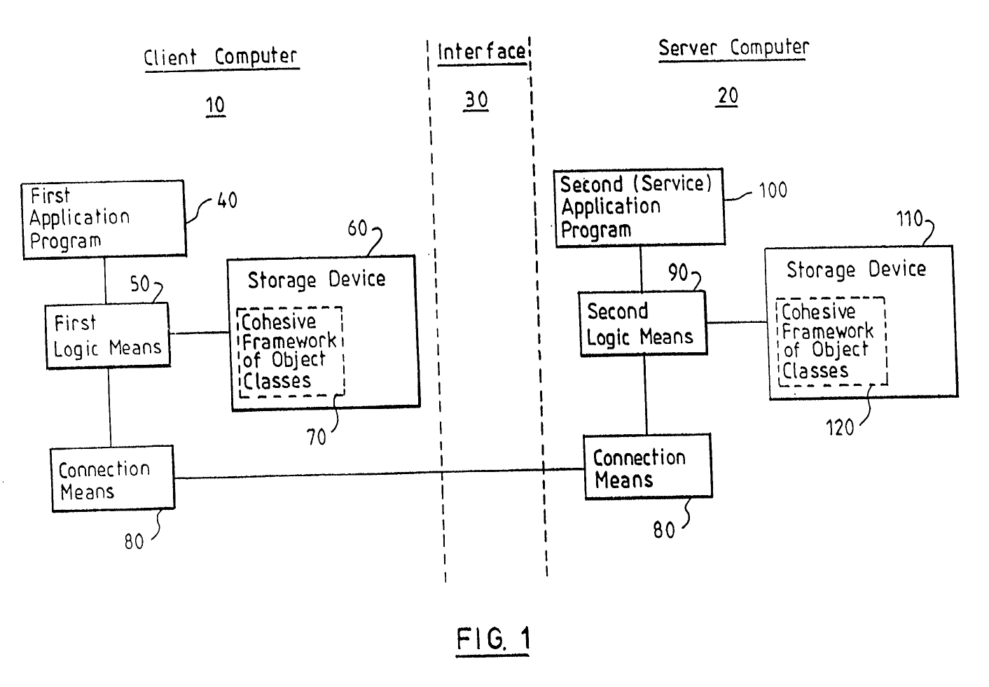

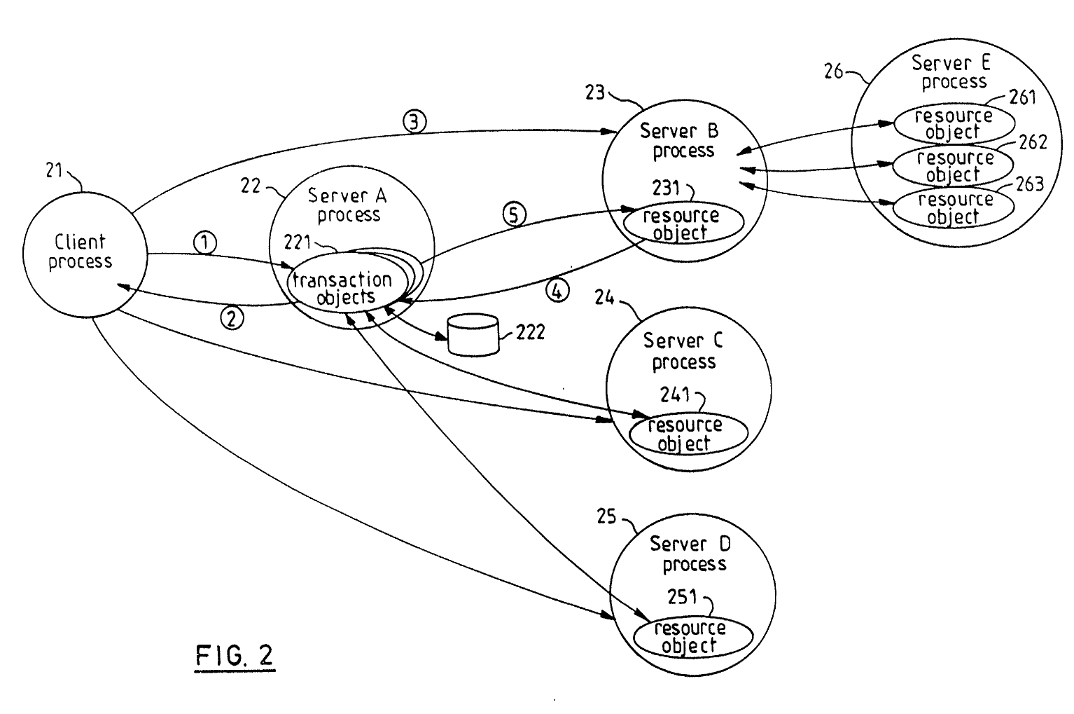

### DETAILED DESCRIPTION OF THE PREFERRED EMBODIMENTS

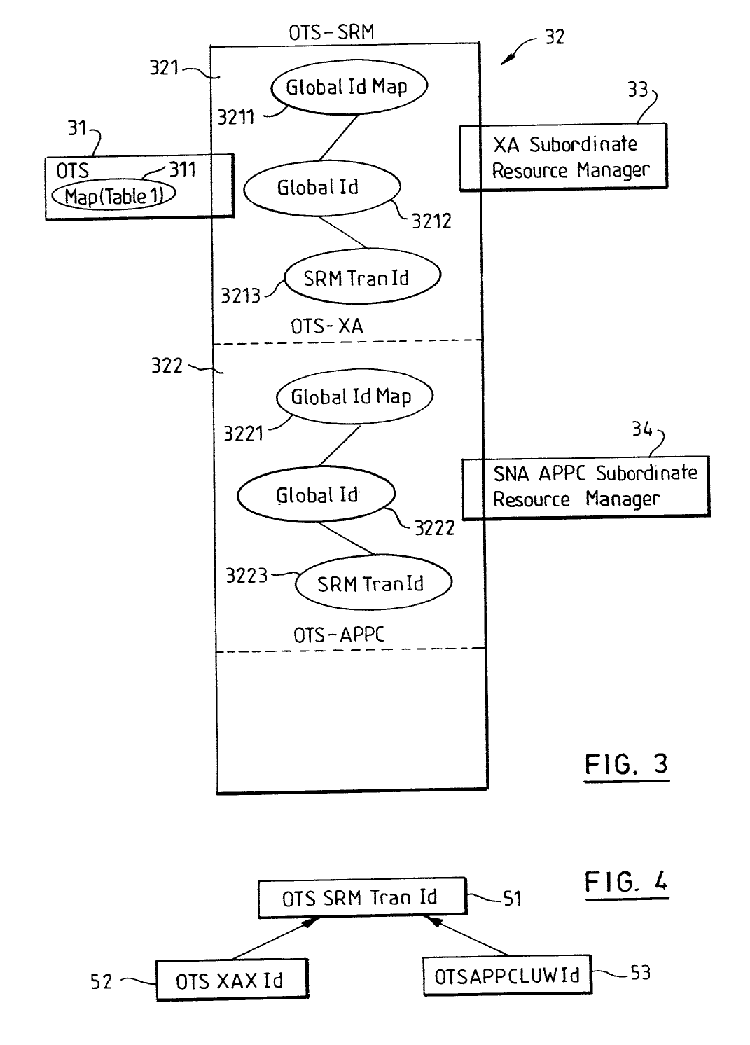

The preferred embodiment of the present invention describes an enhancement (i.e., OTS Subordinate Resource Manager, called hereinafter, OTS-SRM, software block 32 in FIG. 3) to a basic transaction service CORBA OTS implementation (e.g., software block 31) so that transactional information in the format used by any number of subordinate resource managers (e.g., software blocks 33, 34 and 35) can be easily kept synchronized with the dynamically changing list of thread identifier versus transactional information in the format used by the basic transaction service in the CORBA OTS 31.

The software block 32 is provided with classes from which objects can be instantiated in order to provide a single implementation of the code that manages the mapping between an SRM's transaction information and the OTS's transaction information. This saves development time and simplifies the process of maintaining the product. This mapping is static so that only the OTS code (i.e., Table 1) is affected when transactions move from thread to thread. This reduces the chance of the transactional information in the SRMs'formats getting out of step with the transactional information in the format of the basic transaction service. The SRM code is isolated from the mechanism used to look up the “e-current transaction” in the OTS. This means that the SRM code can be reused in a different transaction service implementation.

The OTS 31 still maintains a mapping object 311 of threadId to transaction information (as it did for example in Table 1 discussed above), such a map being held in an object. One of the fields in this transaction information stores a unique number for the transaction called the localId. The OTS-SRM 32 also provides, for each SRM, an implementation of a class called OTSSRMGlobalIdmap, which manages a map of localIds to OTSSRMGlobalId objects (described below). The OTSSRMGlobalIdmap object also contains methods and data for extracting the transaction information from the OTS 31 (and caches it for performance). The implementation of the OTSSRMGlobalId class is also provided by the OTS extension 32. Each SRM mapping code portion (i.e., OTS-XA 321 and OTS-APPC 322) of the OTS extension 32 has an instance of the OTSSRMGlobalIdmap which is called to ask for the “current” GlobalId object. The OTSSRMGlobalIdMap asks the OTS 31 for the current localId and then looks in the map for the corresponding OTSSRMGlobalId object. If one does not exist for the transaction, it is created (which involves extracting information about the transaction from the OTS) and added to the map. Either way, an OTSSRMGlobalId object is returned to the SRM mapping code.

An OTSSRMGlobalId object also caches information from the OTS 31, as well as storing the address of an OTSSRMTranId object, which is an abstract class (a class with abstract methods). Each SRM mapping code portion provides its own tranId subclass (e.g., OTSAPPCLUWId 53 or OTSXAXId 52) which inherits from the superclass OTSSRMTranId class 51, as illustrated by the class diagram of FIG. 4 (of course other subclasses of superclass 51 can be derived should more SRMs be supported). These SRM mapping subclasses (eg OTSAPPCLUWId and OTSXAXId) hold all of the information that relates to their SRM product's view of the transaction. Because the subclasses inherit from the superclass OTSSRMTranId, the subclasses can be stored and extracted from the OTSSRMGlobalId object and so the association between different SRM's and the OTS transaction is maintained with little coding required by each SRM mapping implementation.

The overall software architecture of the transaction server according to the preferred embodiment will now be described. The basic transaction service CORBA OTS 31 contains a mapping table object 311 which keeps track of which transaction is currently associated with each of the server's threads (as described above in conjunction with Table 1). The extension 32 of the OTS 31 has separate SRM mapping code portions, one portion 321 for SRM 33 (called OTS-XA, since it maps between the OTS and the XA SRM 33) and another portion 322 for SRM 34 (called OTS-APPC, since it maps between the OTS and the SNA APPC SRM 34). Other SRM mapping code portions could be provided should other SRMs (e.g., 35 in FIG. 3) be plugged in to the extension 32.

OTS-XA 321 includes a single instantiation 3211 of the GlobalIdMap class, an instantiation 3212 of the GlobalId class (one for each transaction) and an instantiation 3213 of the OTSSRMTranId class 51 (one for each transaction). OTS-APPC 322 includes a single instantiation 3221 of the GlobalIdMap class (one for each transaction), an instantiation 3222 of the GlobalId class (one for each transaction) and an instantiation 3223 of the OTSSRMTranId class 51 (one for each transaction).

The way in which these objects interact will now be further described. A calling object (not shown), that needs to know the XID for the current OTS transaction, calls the GlobalIdMap object 3211 of the OTS-XA mapping block 321 and asks the GlobalIdMap to get the globalId of the current transaction. The calling object is asking for the globalId of the current transaction because once this globalId is known, the calling object can then ask the corresponding GlobalId object for the XID of the current transaction.

The GlobalIdMap object 3211 has a mapping list of localId's versus globalId's so it does not know what the globalId of the current transaction is. The GlobalIdmap object 3211 first needs to know the localId of the current transaction so that it can then use its mapping list to get the corresponding current globalId. Therefore, in order to determine the localId of the current transaction, the GlobalIdMap 3211 calls the map table object 311 of the OTS 31, which returns the localId of the current transaction. The GlobalIdMap 3211 then takes this current localId and looks up the current globalId in the GlobalIdMap's mapping list of localId's versus globalId's. (If, upon looking in its mapping list, the GlobalIdMap object 3211 finds that there is no globalId stored against this current localId, the GlobalIdMap object 3212 sends a create command to a new GlobalId object in order to create a new GlobalID object to represent this current transaction). The GlobalIdMap 3211 then returns the current globalId to the calling object that requested it.

The calling object that requested the current globalId then makes a call to the GlobalId object 3212 requesting that the GlobalId object 3212 provide the calling object with the TranId, which is the XID (in the case of the XA-SRM 33). (If the GlobalId object 3212 returns a NULL reply, indicating that the OTSSRMTranId object has not yet been created, the calling object sends a create command to the XA SRM 33 which in turn sends an add command to the GlobalId 3212 to add the OTSSRMTranId). Since the GlobalId 3212 holds a reference to the OTSSRMTranId 3213, the GlobalId 3212 then simply calls the OTSSRMTranId 3212 to obtain the XID that corresponds to the current transaction, which is then sent to the calling object. It should be noted that when the OTSSRMTranId 3213 is called to get the TranId, this method call is an abstract method in the OTSSRMTranId class 51, meaning that the OTSSRMTranId object 3213 does not contain an implementation of this method, but rather the OTSSRMTranId object 3213 of superclass 51 contains a pointer to an instantiation (not shown) of its OTSXAXId subclass 52, such an instantiation holding the XA transactional information (including the XID which was requested by the calling object).

This implementation is better than prior implementations because the SRMs are associating their transactional information with a fixed value for the transaction (the globalId) rather than trying to keep their own map of tranId information in step with the OTS. In addition, all of the mapping code and the code interacts with the OTS is common. This simplifies the implementation of the current and future SRMs.

In summary, the OTS 31 has a mapping object 311 which maps from threadId to transaction information, such transaction information being in the format of the OTS.

OTS

| | | |
|---|---|---|
| threadId | \|-> | transaction information |
| | | (this includes a “localId” number for |
| | | the transaction) |

The OTS-XA 321 takes a localId that it receives from the OTS's mapping object 311 and maps it to a GlobalId object which in turn identifies a TranId object, which is where the transaction information in the XA format is found.

OTS-XA

| | | |
|---|---|---|
| localId | \|-> | GlobalId object + TranId object |

Likewise, the OTS-APPC 322 takes a localId that it receives from the OTS's mapping object 311, and maps it to a GlobalId object which in turn identifies a TranId object, which is where the transaction information in the APPC format is found.

OTS-APPC

| | | |
|---|---|---|
| localId | \|-> | GlobalId object + TranId object |

The integration support for each subordinate resource manager (SRM) thus provides a class that inherits from the TranId class which it creates a single instance (object) of when it is loaded in to the server.

Thus, by providing the OTS-SRM class as an abstract class (i.e., a superclass with abstract methods), the combined software blocks 31 and 32 can be kept generic in terms of subordinate resource manager implementations. Each subordinate resource manager that then is to be supported is a member of a separate class which inherits from this common generic superclass, thus adding the specifics that relate to the transaction service of the corresponding subordinate resource manager.

While the CORBA OTS has been described in the preferred embodiment as the basic transaction service (e.g., 31) which is controlling/coordinating the transaction and making calls to subordinate resource managers, the use of other transaction services as the basic transaction service besides CORBA OTS is also possible. For example, in another embodiment, the basic transaction service could be the XA transaction service and the CORBA OTS could be the transaction service of an SRM.

I claim:

1. A server apparatus for use in a client/server computing system which coordinates the processing of distributed transactions in the client/server computing system, the apparatus comprising:
(a) a basic transaction service having a table which associates a server thread with transactional information identifying a transaction currently assigned to the server thread, the transactional information being in a format of the basic transaction service, and the information including a first transactional identifier; and
(b) means for maintaining synchronism between the transactional information in the format of the basic transaction service and transactional information in a format of a subordinate resource manager when a server thread switches from one transaction to another transaction, including a mapping means for mapping between the first transactional identifier and a second transactional identifier, wherein the second transactional identifier is associated with a class defining at least one abstract method, the class having a subclass which provides transactional information in the format of the subordinate resource manager.

2. The apparatus of claim 1 wherein the basic transaction service is the Common Object Request Broker's Object Transaction Service.

3. The apparatus of claim 1 wherein the subordinate resource manager is an XA resource manager.

4. The apparatus of claim 1 wherein the first transactional identifier is represented by an integer.

5. A method of operating a server for use in a client/server computing system which coordinates the processing of distributed transactions in the client/server computing system, the method comprising steps of:
receiving a request for transactional information of a current transaction in a format of a subordinate resource manager;
looking up a first transactional identifier in a table which associates a server thread with transactional information identifying a transaction currently assigned to the server thread, the transactional information being in a format of the basic transaction service, and the information including the first transactional identifier;
using the first transactional identifier to look up a second transactional identifier in a table for mapping between the first transactional identifier and a second transactional identifier, wherein the second transactional identifier is associated with a class defining at least one abstract method, the class having a subclass which provides transactional information in the format of the subordinate resource manager;
obtaining the transactional information of the current transaction in the format of the subordinate resource manager from an implementation of the subclass; and
returning the transactional information of the current transaction in the format of a subordinate resource manager as requested.

6. The method of claim 5 wherein the basic transaction service is the Common Object Request Broker's Object Transaction Service.

7. The method of claim 5 wherein the subordinate resource manager is an XA resource manager.

8. The method of claim 5 wherein the first transactional identifier is represented by an integer.

9. A computer program product stored on a computer ireadable storage medium for, when run on a computer, carrying out a server processing method for use in a client/server computing system which coordinates the processing of distributed transactions, said method comprising steps of:
receiving a request for transactional information of a current transaction in a format of a subordinate resource manager;
looking up a first transactional identifier in a table which associates a server thread with transactional information identifying a transaction currently assigned to the server thread, the transactional information being in a format of the basic transaction service, and the information including the first transactional identifier;
using the first transactional identifier to look up a second transactional identifier in a table for mapping between the first transactional identifier and a second transactional identifier, wherein the second transactional identifier is associated with a class defining at least one abstract method, the class having a subclass which provides transactional information in the format of the subordinate resource manager;
obtaining the transactional information of the current transaction in the format of the subordinate resource manager from an implementation of the subclass; and
returning the transactional information of the current transaction in the format of a subordinate resource manager as requested.
